(19) United States
(12) Patent Application Publication
(10) Pub. No.: US 2024/0332874 A1
(43) Pub. Date: Oct. 3, 2024

(54) INTERCHANGEABLE ADAPTER, CORRESPONDING SYSTEM AND KIT

(71) Applicant: Rohde & Schwarz GmbH & Co. KG, Munich (DE)

(72) Inventors: Sebastian SEDLMEIER, Munich (DE); Markus FREUDENREICH, Munich (DE); Markus LEIPOLD, Isen (DE)

(73) Assignee: Rohde & Schwarz GmbH & Co. KG, Munich (DE)

(21) Appl. No.: 18/192,767

(22) Filed: Mar. 30, 2023

(51) Int. Cl. H01R 24/54

(52) U.S. Cl. CPC H01R 24/542

(57) ABSTRACT

An interchangeable adapter for connecting coaxial connectors is provided. The adapter includes an inner conductor galvanically connectable or connected to an inner conductor of one coaxial connector, and an outer conductor is galvanically connectable or connected to an outer conductor of the coaxial connector. The outer conductor includes a main body and a hollow contacting segment. The hollow contacting segment extends from the main body in an axial direction of the inner conductor. The inner conductor is in the hollow contacting segment, and the hollow contacting segment is elastical. An end face of the hollow contacting segment contacts a contact area of the outer conductor of the second coaxial connector. The outer conductor of the adapter includes stop surface. The stop surface contacts a stop surface at the outer conductor when contact a pressure exceeds a threshold, thereby limiting the contact pressure.

### TECHNICAL FIELD

The disclosure relates to an interchangeable adapter, a corresponding system, and a corresponding kit. In particular, the disclosure relates to interchangeable adapter for connecting a first coaxial connector to a second coaxial connector, a system comprising such an interchangeable adapter, and a kit comprising at least one of such an interchangeable adapter.

### BACKGROUND ART

For instance, the sockets or ports, respectively, of a measuring device have a decisive influence on the measurement result especially for analog signals. If the corresponding connection or coaxial connection, respectively, to a device under test or other measuring device is made incorrectly, for example, because screw connections of union nuts are tightened too tightly, then this can lead to the socket or port, respectively, being damaged and a new connection would lead to a different measurement result.

U.S. Pat. No. 4,687,279 A discloses a high frequency coaxial connector adaptor assembly for mating an APC-7 precision connector member to any of a set of coaxial connectors including N type, TNC type, and SMA type connectors. Said adaptor assembly utilizes a first connector body having an APC-7 interface at one end and having an open structure at the other end with an extended center conductor and outer conducting bushing to interface with any one of the set of coaxial connectors which are specially adapted at one end to engage the open structure of the first connector body.

Disadvantageously, the structure of said adaptor assembly does not allow for reliably preventing coaxial connectors, such as ports of measuring devices, from being damaged by making the corresponding coaxial connection incorrectly.

### SUMMARY

Thus, there is a need to provide an interchangeable adapter, a corresponding system, and a corresponding kit, which allow for preventing coaxial connectors, such as ports of measuring devices, from being damaged by making the corresponding coaxial connection incorrectly in a particularly reliable and efficient manner.

This is achieved by the embodiments provided in the enclosed independent claims. Advantageous implementations of the present disclosure are further defined in the dependent claims.

According to a first aspect of the present disclosure, an interchangeable adapter for connecting a first coaxial connector to a second coaxial connector is provided. Said interchangeable adapter comprises an inner conductor configured to be galvanically connectable and/or connected to an inner conductor of the second coaxial connector, and an outer conductor configured to be galvanically connectable and/or connected to an outer conductor of the second coaxial connector. In this context, the outer conductor comprises a main body and a hollow contacting segment, wherein the hollow contacting segment extends from the main body in an axial direction of the inner conductor. In addition to this, the inner conductor is arranged within the hollow contacting segment, and the hollow contacting segment is elastical in axial and/or lateral direction. Further additionally, an end face of the hollow contacting segment is configured to be brought into contact with a contact area of the outer conductor of the second coaxial connector, such that a ground connection between the outer conductor of the interchangeable adapter and the second coaxial connector is established. In further addition to this, the outer conductor of the interchangeable adapter comprises at least one stop surface, wherein the at least one stop surface is configured to be brought into contact with a corresponding stop surface at the outer conductor of the second coaxial connector if a contact pressure between the hollow contacting segment and the contact area of the outer conductor of the second coaxial connector exceeds a threshold, thereby limiting the contact pressure.

Advantageously, this allows for preventing coaxial connectors, such as ports of measuring devices, from being damaged by making the corresponding coaxial connection incorrectly in a particularly reliable and efficient manner.

Further advantageously, for instance, even if a screw connection is tightened too hard and the interchangeable adapter is pushed onto the port or socket, respectively, of a measurement device too hard, the port or socket, respectively, of the measurement device will change shape because the outer conductor of the interchangeable adapter is designed in such a way that it absorbs forces in the axial direction, especially in the corresponding plug-on direction, and is deformed before the port or socket, respectively, is damaged. Moreover, the interchangeable adapter can be replaced more cost-effectively than the port or socket, respectively, of the measurement device, which is normally switched off for this purpose and is no longer available for measurements during this period of corresponding replacement.

As a further advantage, especially in the foregoing context, the deformation of the outer conductor of the interchangeable adapter also ensures that the contact force or contact pressure, respectively, with which the outer conductor of the interchangeable adapter presses on the end face of the outer conductor of the port or socket, respectively, is always the same. For example, threads may be dirty, so that the required contact pressure is not achieved. Further exemplarily, regardless of how strongly a corresponding union nut of a port or socket, respectively is tightened, the same contact pressure is always applied at the junction of the electrical outer conductor contact between the interchangeable adapter and the port or socket, respectively, which may especially be seen as the second coaxial connector.

Moreover, it is noted that it might be advantageous to provide a measurement device comprising at least one port or measurement port, respectively, wherein at least one or each of the at least one port or measurement port, respectively, comprises the above-mentioned hollow contacting segment.

It is further noted that the above-mentioned ground connection is preferably made only on the end face.

According to an embodiment of the first aspect of the present disclosure, the first coaxial connector is a coaxial connector of a coaxial cable or a coaxial device or a device under test. Additionally or alternatively, the first coaxial connector comprises or is a coaxial plug.

Advantageously, for instance, the interchangeable adapter may provide a port or a socket, respectively, especially for connecting to a device under test or measurement equipment.

According to an embodiment of the first aspect of the present disclosure, the second coaxial connector is a coaxial connector of a coaxial cable or a coaxial system or a measurement device. In addition to this or as an alternative, the second coaxial connector comprises or is a coaxial socket.

Advantageously, for example, the interchangeable adapter may be attached to a port or a socket, respectively, of a measurement device especially by plugging and/or screwing. Further advantageously, the coaxial socket can especially be a port or a measurement port, respectively, exemplarily of a measurement device. It should be mentioned that a port or a socket, respectively, of the present disclosure can especially be seen as the second coaxial connector of the present disclosure, and vice versa.

According to an embodiment of the first aspect of the present disclosure, the at least one stop surface is spaced further away from the inner conductor than the end face of the hollow contacting segment.

Advantageously, no current flows over the stop surface. If the stop surface, especially being either the one of the interchangeable adapter or the one of the second coaxial connector, is damaged, then a new interchangeable adapter can easily be mounted, because the real electrical contact at the end face of the hollow contacting segment or the corresponding contact area at the second coaxial connector remains undamaged.

Further advantageously, especially in the foregoing context, there may be two contacting surfaces. The electrical contact, via which the current flow takes place, is arranged on the part of the outer conductor of the interchangeable adapter that can be deformed in the axial direction. However, the interchangeable adapter can additionally come into contact with the outer conductor of the second coaxial connector or a port or socket, respectively, via a further contact shoulder in the outer conductor. This further contact shoulder is spaced further from the inner conductor than the normal electrical contact. This further contact shoulder then blocks further deformation of the first contact so that it is not irreparably compressed. Deformations on the outer conductor of the second coaxial connector or port or socket, respectively, that occur via the additional contact shoulder are irrelevant for the measurement result because no currents flow via this. Accordingly, it can also be said that there may be an electrical connection and a mechanical connection.

According to an embodiment of the first aspect of the present disclosure, the hollow contacting segment is configured to be shortened if the interchangeable adapter is pressed towards the second coaxial connector, thereby especially allowing the at least one stop surface of the interchangeable adapter to be brought into contact with the corresponding stop surface of the second coaxial connector.

Advantageously, for instance, not only reliability but also efficiency with respect to damage prevention can further be increased, which can analogously apply for both the following embodiment and embodiments which do not explicitly mention an advantage.

According to an embodiment of the first aspect of the present disclosure, the hollow contacting segment comprises a thickness in radial direction that is selected such that the contact force being achievable between the end face of the hollow contacting segment and the contact area of the outer conductor of the second coaxial connector is below a threshold, thereby especially avoiding any damages to the contact area of the outer conductor of the second coaxial connector.

According to an embodiment of the first aspect of the present disclosure, the hollow contacting segment comprises a smaller diameter and/or a smaller cross section than the main body of the outer conductor of the interchangeable adapter.

Advantageously, with respect to the cross section, it is noted that the cross section can especially be of a circular shape or an oval shape or a rectangular shape.

According to an embodiment of the first aspect of the present disclosure, the hollow contacting segment comprises a smaller wall thickness than the main body of the outer conductor of the interchangeable adapter.

According to an embodiment of the first aspect of the present disclosure, a diameter and/or cross section and/or wall thickness of the hollow contacting segment is larger at an end region comprising the end face than in the correspondingly remaining region.

Advantageously, with respect to the correspondingly remaining region, it is noted that the correspondingly remaining region is elastic. It is further noted that the correspondingly remaining region especially starts at the main body of the outer conductor.

According to an embodiment of the first aspect of the present disclosure, the wall thickness of the correspondingly remaining region is 1 mm or deviates by less than 20%, or by less than 10%, or by less than 5% from that, or is 0.165 mm or deviates by less than 20%, or by less than 10%, or by less than 5% from that.

According to an embodiment of the first aspect of the present disclosure, the length of the correspondingly remaining region is less than 20 mm or less than 15 mm or less than 10 mm or less than 5 mm, or is 1.312 mm or deviates by less than 20%, or by less than 10%, or by less than 5% from that.

Advantageously, the correspondingly remaining region may especially be bellows-like and/or corrugated. Further advantageously, especially with respect to the hollow contacting segment, a corresponding spring constant can be adjusted by the wall thickness of the correspondingly remaining region and/or the length of the correspondingly remaining region.

According to an embodiment of the first aspect of the present disclosure, the main body and the hollow contacting segment are or form a single piece.

Advantageously, for instance, efficiency can be increased especially in the sense of a flexibly choosing the kind of manufacturing, which can analogously apply for the following embodiment.

According to an embodiment of the first aspect of the present disclosure, the main body and the hollow contacting segment are or form two separate parts, wherein the hollow contacting segment is slid and/or pressed into a recess within the main body.

According to an embodiment of the first aspect of the present disclosure, the hollow contacting segment consists of copper beryllium or comprises copper beryllium. Additionally or alternatively, the hollow contacting segment comprises at least one of copper, a copper alloy, stainless steel, aluminum, an aluminum alloy, brass, a brass alloy, plastic comprising an electrically conductive coating, an elastic or springy and electrically conductive material, or any combination thereof.

Advantageously, the main body may especially consist of copper beryllium or comprise copper beryllium. Further advantageously, the hollow contacting segment and/or the main body may comprise a certain amount of lead.

According to an embodiment of the first aspect of the present disclosure, the hollow contacting segment is symmetric especially in radial direction. As an alternative, the hollow contacting segment is not symmetric especially in radial direction.

Advantageously, the corresponding cross section of the hollow contacting segment can especially be of a circular shape or an oval shape.

According to an embodiment of the first aspect of the present disclosure, the hollow contacting segment is free of openings in its circumferential wall.

Advantageously, there is an opening for the inner conductor, whereas the hollow contacting segment is not bent in radial direction, therefore it does not need slots in axial direction.

According to an embodiment of the first aspect of the present disclosure, the hollow contacting segment is configured to be more deformed in the axial direction than in the radial direction when the interchangeable adapter is pressed onto the second coaxial connector.

According to an embodiment of the first aspect of the present disclosure, the hollow contacting segment is free of a galvanical contact in radial direction to the outer conductor of the second coaxial connector.

Advantageously, the galvanical contact is only at the end face. Further advantageously, there is no elastical action or spring action, respectively, radially outward or radially inward.

According to a second aspect of the present disclosure, a system is provided. Said system comprises an interchangeable adapter according to the first aspect of the present disclosure, and a coaxial system. In this context, the interchangeable adapter is connected and/or screwed to and/or plugged into the coaxial system, such that the inner conductor of the interchangeable adapter is galvanically connected to the inner conductor of the coaxial system, and such that the outer conductor of the interchangeable adapter is galvanically connected through its hollow contacting segment to the outer conductor of the coaxial system.

Advantageously, this allows for preventing coaxial connectors, such as ports of measuring devices, from being damaged by making the corresponding coaxial connection incorrectly in a particularly reliable and efficient manner.

It is noted that the coaxial system of the system according to the second aspect of the present disclosure may especially be understood by analogy with the second coaxial connector mentioned in the context of the interchangeable adapter according to the first aspect of the present disclosure. It is further noted that said coaxial system may comprise a coaxial connector, wherein said coaxial connector of the coaxial system may especially be understood as the second coaxial connector mentioned in the context of the interchangeable adapter.

According to a third aspect of the present disclosure, a kit is provided. Said kit comprises a measurement device comprising at least one port, and at least one interchangeable adapter according to the first aspect of the present disclosure for being connected and/or screwed to and/or plugged into the at last one port.

Advantageously, this allows for preventing coaxial connectors, such as ports of measuring devices, from being damaged by making the corresponding coaxial connection incorrectly in a particularly reliable and efficient manner.

It is noted that a port of the measurement device of the kit according to the third aspect of the present disclosure may especially be understood by analogy with the second coaxial connector mentioned in the context of the interchangeable adapter according to the first aspect of the present disclosure. It is further noted that said port may comprise a coaxial connector, wherein said coaxial connector of the port may especially be understood as the second coaxial connector mentioned in the context of the interchangeable adapter.

### BRIEF DESCRIPTION OF THE DRAWINGS

The above-described aspects and implementation forms of the present disclosure will be explained in the following description of specific embodiments in relation to the enclosed drawings, in which:

FIG. 1 shows a three-dimensional view of an exemplary embodiment of the interchangeable adapter, especially the outer conductor thereof;

FIG. 2 shows a section view of the embodiment of FIG. 1;

FIG. 3 shows a partial section view of the exemplary embodiment of the interchangeable adapter according to FIG. 1 in combination with a coaxial system or second coaxial connector, respectively;

FIG. 4 shows a section view of the embodiment of FIG. 3; and

FIG. 5 shows an exemplary embodiment of the system according to the second aspect or the kit according to the third aspect, respectively.

### DETAILED DESCRIPTIONS OF EMBODIMENTS

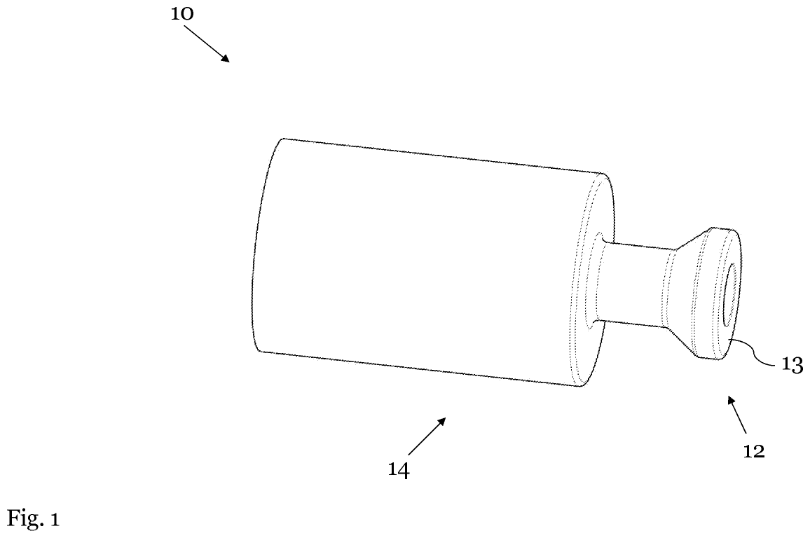

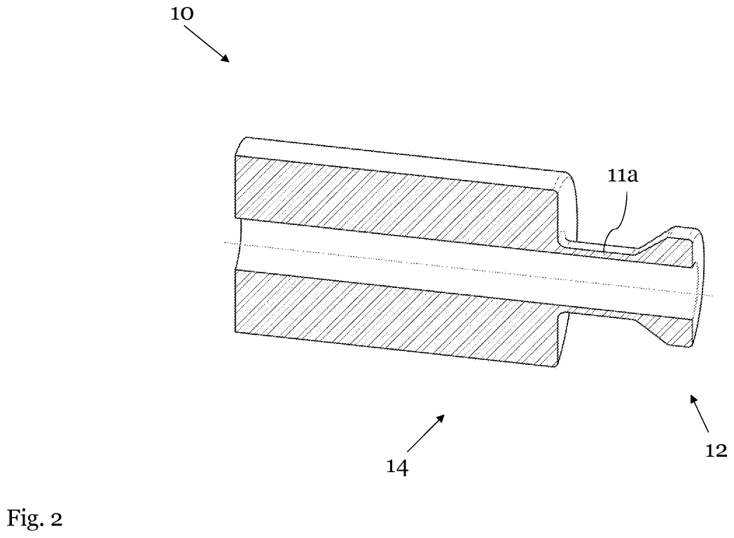

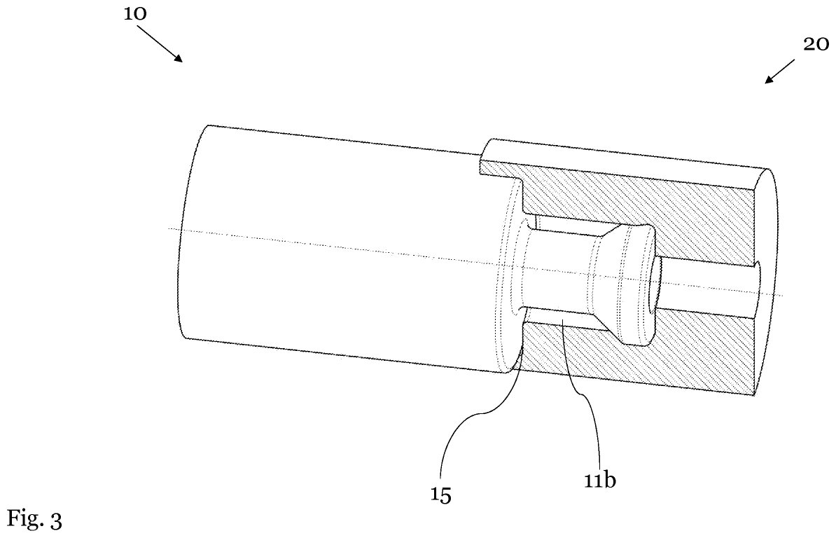

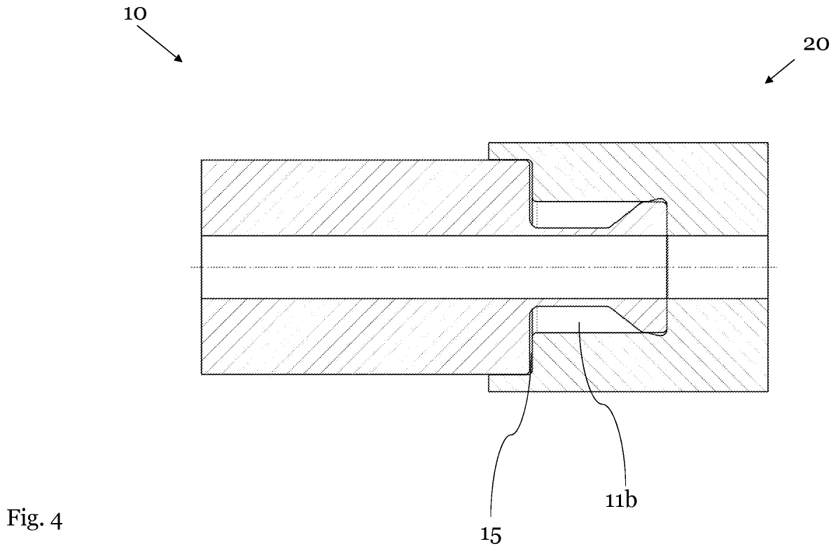

Due to the fact that each of the FIG. 1, FIG. 2, FIG. 3, and FIG. 4 comprise the same exemplary embodiment 10 of the interchangeable adapter of the first aspect of the present disclosure, especially the outer conductor thereof, wherein FIG. 3 and FIG. 4 additionally depict the second coaxial connector 20 in the context thereof, and due to a manageable number of corresponding reference signs, it seems to be appropriate and efficient to explain said embodiment 10 in the following without explicitly mentioning the respective one of said figures.

In accordance with the exemplary embodiment 10, the interchangeable adapter for connecting a first coaxial connector to the second coaxial connector 20 comprises an inner conductor configured to be galvanically connectable and/or connected to an inner conductor of the second coaxial connector 20, and an outer conductor configured to be galvanically connectable and/or connected to an outer conductor of the second coaxial connector 20.

In this context, the outer conductor comprises a main body 14 and a hollow contacting segment 12, wherein the hollow contacting segment 12 extends from the main body 14 in an axial direction of the inner conductor.

Furthermore, the inner conductor is arranged within the hollow contacting segment 12. Accordingly, for the sake of completeness, it is noted that due to said arrangement, the inner conductor cannot be seen in the figures.

Moreover, the hollow contacting segment 12 is elastical in axial and/or lateral direction. It is noted that the hollow contacting segment 12 can especially be springy.

Additionally, an end face 13 of the hollow contacting segment 12 is configured to be brought into contact with a contact area of the outer conductor of the second coaxial connector 20, such that a ground connection between the outer conductor of the interchangeable adapter and the second coaxial connector 20 is established.

It is noted that it might be advantageous if the end face 13 is rotationally symmetric. It is further noted that the end face 13 may be of a circular shape. Additionally or alternatively, the end face 13 may comprise a diameter of 1.35 mm or may deviate by less than 20%, or by less than 10%, or by less than 5% from that.

Furthermore, also in accordance with the exemplary embodiment 10, the outer conductor of the interchangeable adapter comprises at least one stop surface, wherein the at least one stop surface is configured to be brought into contact with a corresponding stop surface at the outer conductor of the second coaxial connector 20 if a contact pressure between the hollow contacting segment 12 and the contact area of the outer conductor of the second coaxial connector 20 exceeds a threshold, thereby limiting the contact pressure.

With respect to the first coaxial connector, it is noted that it might be advantageous if the first coaxial connector is a coaxial connector of a coaxial cable or a coaxial device or a device under test. Additionally or alternatively, the first coaxial connector may comprise or be a coaxial plug.

With respect to the second coaxial connector 20, it is noted that it might be advantageous if the second coaxial connector 20 is a coaxial connector of a coaxial cable or a coaxial system or a measurement device. In addition to this or as an alternative, the second coaxial connector 20 may comprise or be a coaxial socket.

Especially in the context of a measurement device with ports or coaxial sockets, respectively, it might be advantageous if the interchangeable adapter is attached to a port or socket, respectively, of the measurement device especially by plugging and/or screwing, wherein the interchangeable adapter itself provides a port or socket, respectively, especially for connecting to a device under test or another measurement device.

Advantageously, if the wiring to the device under test or the other measurement device is made incorrectly, the interchangeable adapter can be damaged, but not the port or socket, respectively, of the measurement device.

Further advantageously, the interchangeable adapter can be replaced more cost-effectively than the port or socket, respectively, of the measurement device, which is normally switched off for this purpose and is no longer available for measurements during this period.

With respect to the above-mentioned at least one stop surface, it is noted that it might be advantageous if the at least one stop surface is spaced further away from the inner conductor than the end face 13 of the hollow contacting segment 12.

It is further noted that it might be advantageous if the hollow contacting segment 12 is configured to be shortened if the interchangeable adapter is pressed towards the second coaxial connector 20, thereby especially allowing the at least one stop surface of the interchangeable adapter to be brought into contact with the corresponding stop surface of the second coaxial connector 20.

With respect to the hollow contacting segment 12, it is noted that it might be advantageous if the hollow contacting segment 12 comprises a thickness in radial direction that is selected such that the contact force being achievable between the end face 13 of the hollow contacting segment 12 and the contact area of the outer conductor of the second coaxial connector 20 is below a threshold, thereby especially avoiding any damages to the contact area of the outer conductor of the second coaxial connector 20.

Furthermore, the hollow contacting segment 12 exemplarily comprises a smaller diameter and/or a smaller cross section than the main body 14 of the outer conductor of the interchangeable adapter.

Moreover, the hollow contacting segment 12 exemplarily comprises a smaller wall thickness than the main body 14 of the outer conductor of the interchangeable adapter.

In addition, a diameter and/or cross section and/or wall thickness of the hollow contacting segment 12 is larger at an end region comprising the end face 13 than in the correspondingly remaining region.

In this context, it is noted that it might be advantageous if the wall thickness, being exemplarily illustrated with the aid of reference sign 11a, of the correspondingly remaining region is 1 mm or deviates by less than 20%, or by less than 10%, or by less than 5% from that, or is 0.165 mm or deviates by less than 20%, or by less than 10%, or by less than 5% from that. Advantageously, this area 11a especially ensures the spring action in the axial direction.

In addition to this or as an alternative, the length, being exemplarily illustrated with the aid of reference sign 11b, of the correspondingly remaining region is less than 20 mm or less than 15 mm or less than 10 mm or less than 5 mm, or is 1.312 mm or deviates by less than 20%, or by less than 10%, or by less than 5% from that.

As exemplarily illustrated with the aid of reference sign 15, there exemplarily is a defined gap between the main body 14 of the outer conductor of the interchangeable adapter and the corresponding area of the second coaxial connector 20.

Accordingly, it might be advantageous if main body 14 of the outer conductor of the interchangeable adapter is configured such that the main body 14 and the corresponding area of the second coaxial connector 20 form the defined gap 15 especially when the end face 13 of the hollow contacting segment 12 is in contact with the contact area of the outer conductor of the second coaxial connector 20.

With respect to said defined gap 15, it is noted that it might be advantageous if the defined gap 15 is 15 micrometers or deviates by less than 33.3%, or by less than 20%, or by less than 10%, or by less than 5% from that.

With respect to the main body 14 and the hollow contacting segment 12, it is noted that it might be advantageous if the main body 14 and the hollow contacting segment 12 are or form a single piece.

As an alternative, the main body 14 and the hollow contacting segment 12 are or form two separate parts, wherein the hollow contacting segment 12 may be slid and/or pressed into a recess within the main body 14.

With respect to the hollow contacting segment 12, it is noted that it might be advantageous if the hollow contacting segment 12 comprises or is made of copper beryllium and/or CuBe2 and/or CuBe2 R620 and/or CuBe2Pb and/or CuBe2Pb R620 and/or CuBe2PB F650 and/or copper and/or a copper alloy and/or stainless steel and/or aluminum and/or an aluminum alloy and/or brass and/or a brass alloy and/or plastic comprising an electrically conductive coating and/or an elastic or springy and electrically conductive material. Further advantageously, the hollow contacting segment 12 may be coated with gold and/or hard gold and/or silver. Advantageously, the corresponding spring properties may especially be independent of the coating.

With respect to the second coaxial connector 20, it is noted that it might be advantageous if the second coaxial connector 20 comprises or is made of high-grade steel and/or Niro 1.4305 and/or brass and/or CuZn39Pb2 and/or aluminum and/or AlMgSi1 and/or AlMgSi1 F28 and/or copper and/or a copper alloy and/or stainless steel and/or aluminum and/or an aluminum alloy and/or brass and/or a brass alloy and/or copper beryllium.

Again, with respect to the hollow contacting segment 12, it is noted that the hollow contacting 12 segment is exemplarily symmetric in radial direction. In addition to this, the hollow contacting segment 12 is exemplarily free of openings in its circumferential wall.

It is noted that it might be advantageous if the hollow contacting segment 12, especially the above-mentioned area 11a, is configured to be more deformed in the axial direction than in the radial direction when the interchangeable adapter is pressed onto the second coaxial connector 20.

It is further noted that the hollow contacting segment 12 may be free of a galvanical contact in radial direction to the outer conductor of the second coaxial connector 20.

With general respect to the interchangeable adapter, it should be mentioned that the interchangeable adapter can especially be seen as a sacrificial adapter. Accordingly, the interchangeable adapter may especially comprise or be a sacrificial adapter.

Advantageously, the sacrificial adapter is designed in such a way that it dissipates an excessive tightening torque so that the end face of the port or socket, respectively, which is used for contact with the sacrificial adapter, in particular with the corresponding outer conductor, does not suffer any permanent damage, exemplarily in the form of dents or indentations. Accordingly, even if an incorrect or no torque wrench is used, there is no permanent damage to fear.

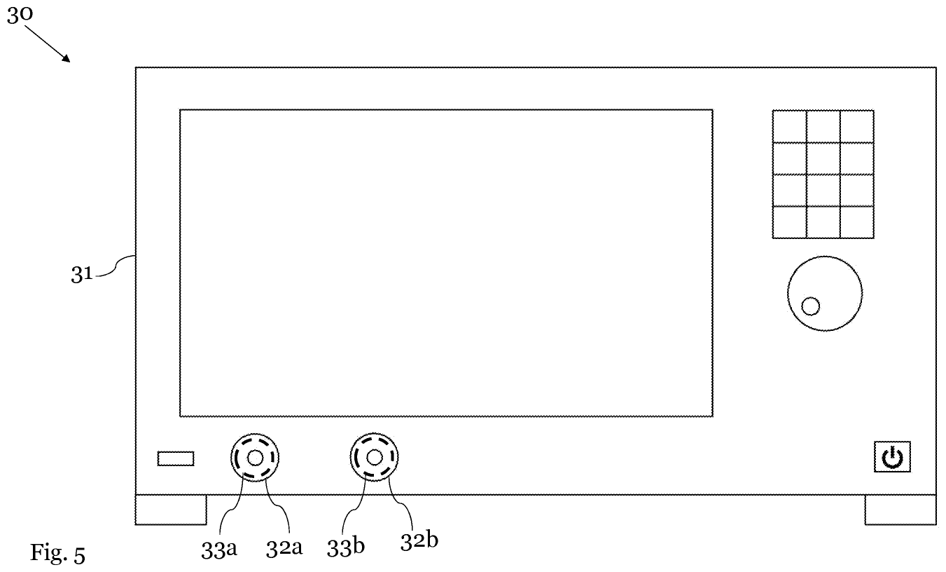

Finally, with respect to FIG. 5, an exemplary embodiment 30 of the system according to the second aspect of the present disclosure or the kit according to the third aspect of the present disclosure, respectively, is depicted.

With respect to said kit, it is noted that the kit comprises a measurement device comprising at least one port, exemplarily the measurement device 31 comprising two ports 32a, 32b, and at least one interchangeable adapter, exemplarily two interchangeable adapters 33a, 33b, according to the first aspect of the present disclosure, such as the interchangeable adapter described above with the aid of FIG. 1, FIG. 2. FIG. 3, and FIG. 4, each for being connected and/or screwed to and/or plugged into the at last one port, exemplarily the ports 32a, 32b.

With respect to the two ports 32a, 32b of the measurement device, it is noted that each of said ports 32a. 32b can especially comprise or be a coaxial connector or a coaxial socket. Furthermore, each of said ports 32a, 32b may especially be seen as the second coaxial connector 20 according to explanations regarding FIG. 1, FIG. 2, FIG. 3, and FIG. 4 above. Accordingly, all the explanations above regarding said second coaxial connector 20 can analogously apply for each of the ports 32a, 32b, and vice versa.

Especially for the case that at least one of the interchangeable adapters 33a, 33b is connected and/or screwed to and/or plugged into the respective one of the ports 32a, 32b, the embodiment 30 also illustrates the system according to the second aspect of the present disclosure.

Basically, it is noted that such a system comprises such an interchangeable adapter or at least one interchangeable adapter of the interchangeable adapters 33a, 33b, respectively, and a coaxial system, wherein the respective interchangeable adapter is connected and/or screwed to and/or plugged into the corresponding coaxial system, such that the inner conductor of the interchangeable adapter is galvanically connected to the inner conductor of the coaxial system, and such that the outer conductor of the interchangeable adapter is galvanically connected through its hollow contacting segment to the outer conductor of the coaxial system.

With respect to said coaxial system, it is noted that each of the ports 32a, 32b of the measurement device 31 can especially comprise or be such a coaxial system. Furthermore, said coaxial system can especially comprise or be a coaxial connector or a coaxial socket as mentioned in the context of the kit. Moreover, each of said ports 32a, 32b may especially be seen as the second coaxial connector 20 according to explanations regarding FIG. 1, FIG. 2, FIG. 3, and FIG. 4 above. Accordingly, all the explanations above regarding said second coaxial connector 20 can analogously apply for said coaxial system, and vice versa.

Within the scope of the explanations regarding FIG. 5, it is noted that it might be advantageous to provide a measurement device, such as the measurement device 31, comprising at least one port or measurement port, respectively, such as the ports 32a, 32b, wherein at least one or each of the at least one port or measurement port, respectively, comprises the above-mentioned hollow contacting segment 12. In this context, the hollow contacting segment 12 may especially be integrated into the respective one of the ports 32a, 32b or measurement ports, respectively.

All features described above or features shown in the figures can be combined with each other in any advantageous manner within the scope of the disclosure.

1. An interchangeable adapter for connecting a first coaxial connector to a second coaxial connector, the interchangeable adapter comprising:
an inner conductor configured to be galvanically connectable and/or connected to an inner conductor of the second coaxial connector, and
an outer conductor configured to be galvanically connectable and/or connected to an outer conductor of the second coaxial connector,
wherein the outer conductor comprises a main body and a hollow contacting segment, wherein the hollow contacting segment extends from the main body in an axial direction of the inner conductor,
wherein the inner conductor is arranged within the hollow contacting segment,
wherein the hollow contacting segment is elastical in axial direction,
wherein an end face of the hollow contacting segment is configured to be brought into contact with a contact area of the outer conductor of the second coaxial connector, such that a ground connection between the outer conductor of the interchangeable adapter and the second coaxial connector is established,
wherein the outer conductor of the interchangeable adapter comprises at least one stop surface,
wherein the at least one stop surface is configured to be brought into contact with a corresponding stop surface at the outer conductor of the second coaxial connector if a contact pressure between the hollow contacting segment and the contact area of the outer conductor of the second coaxial connector exceeds a threshold, thereby limiting the contact pressure.

2. The interchangeable adapter according to claim 1,
wherein the first coaxial connector is a coaxial connector of a coaxial cable or a coaxial device or a device under test, and/or
wherein the first coaxial connector comprises or is a coaxial plug.

3. The interchangeable adapter according to claim 1,
wherein the second coaxial connector is a coaxial connector of a coaxial cable or a coaxial system or a measurement device, and/or
wherein the second coaxial connector comprises or is a coaxial socket.

4. The interchangeable adapter according to claim 1,
wherein the at least one stop surface is spaced further away from the inner conductor than the end face of the hollow contacting segment.

5. The interchangeable adapter according to claim 1,
wherein the hollow contacting segment is configured to be shortened if the interchangeable adapter is pressed towards the second coaxial connector, thereby especially allowing the at least one stop surface of the interchangeable adapter to be brought into contact with the corresponding stop surface of the second coaxial connector.

6. The interchangeable adapter according to claim 1,
wherein the hollow contacting segment comprises a thickness in radial direction that is selected such that the contact force being achievable between the end face of the hollow contacting segment and the contact area of the outer conductor of the second coaxial connector is below a threshold, thereby especially avoiding any damages to the contact area of the outer conductor of the second coaxial connector.

7. The interchangeable adapter according to claim 1,
wherein the hollow contacting segment comprises a smaller diameter and/or a smaller cross section than the main body of the outer conductor of the interchangeable adapter.

8. The interchangeable adapter according to claim 1,
wherein the hollow contacting segment comprises a smaller wall thickness than the main body of the outer conductor of the interchangeable adapter.

9. The interchangeable adapter according to claim 1,
wherein a diameter and/or cross section and/or wall thickness of the hollow contacting segment is larger at an end region comprising the end face than in the correspondingly remaining region.

10. The interchangeable adapter according to claim 9,
wherein the wall thickness of the correspondingly remaining region is 1 mm or deviates by less than 20%, or by less than 10%, or by less than 5% from that, or is 0.165 mm or deviates by less than 20%, or by less than 10%, or by less than 5% from that.

11. The interchangeable adapter according to claim 9,
wherein the length of the correspondingly remaining region is less than 20 mm or less than 15 mm or less than 10 mm or less than 5 mm, or is 1.312 mm or deviates by less than 20%, or by less than 10%, or by less than 5% from that.

12. The interchangeable adapter according to claim 1,
wherein the main body and the hollow contacting segment are or form a single piece.

13. The interchangeable adapter according to claim 1,
wherein the main body and the hollow contacting segment are or form two separate parts, wherein the hollow contacting segment is slid and/or pressed into a recess within the main body.

14. The interchangeable adapter according to claim 1,
wherein the hollow contacting segment consists of copper beryllium or comprises copper beryllium, and/or
wherein the hollow contacting segment comprises at least one of copper, a copper alloy, stainless steel, aluminum, an aluminum alloy, brass, a brass alloy, plastic comprising an electrically conductive coating, an elastic or springy and electrically conductive material, or any combination thereof.

15. The interchangeable adapter according to claim 1,
wherein the hollow contacting segment is symmetric especially in radial direction, or
wherein the hollow contacting segment is not symmetric especially in radial direction.

16. The interchangeable adapter according to claim 1,
wherein the hollow contacting segment is free of openings in its circumferential wall.

17. The interchangeable adapter according to claim 1,
wherein the hollow contacting segment is configured to be more deformed in the axial direction than in the radial direction when the interchangeable adapter is pressed onto the second coaxial connector.

18. The interchangeable adapter according to claim 1,
wherein the hollow contacting segment is free of a galvanical contact in radial direction to the outer conductor of the second coaxial connector.

19. A system comprising:
an interchangeable adapter according to claim 1, and
a coaxial system,
wherein the interchangeable adapter is connected and/or screwed to and/or plugged into the coaxial system, such that the inner conductor of the interchangeable adapter is galvanically connected to the inner conductor of the coaxial system, and such that the outer conductor of the interchangeable adapter is galvanically connected through its hollow contacting segment to the outer conductor of the coaxial system.

20. A kit comprising:
a measurement device comprising at least one port, and
at least one interchangeable adapter according to claim 1 for being connected and/or screwed to and/or plugged into the at last one port.
